(19) United States
(12) Patent Application Publication
(10) Pub. No.: US 2007/0069701 A1
(43) Pub. Date: Mar. 29, 2007

(54) Low cost stability improvement for a linear voltage regulator

(75) Inventors: Jerome Gentillet, Round Rock, TX (US); Dave Tobin, Round Rock, TX (US); Raojibhai Patel, Round Rock, TX (US)

Correspondence Address: BAKER BOTTS, LLP, 910 LOUISIANA, HOUSTON, TX, 77002-4995, US

(73) Assignee: Dell Products L.P.

(21) Appl. No.: 11/240,980

(22) Filed: Sep. 29, 2005

(51) Int. Cl. G05F 1/00

(52) U.S. Cl. 323/273

(57) ABSTRACT

An information handling system has a printed circuit board power supply using a linear regulator and a very low ESR output capacitor. At least one printed circuit board conductive land having a desired resistance and coupled between the output capacitor and linear regulator output terminal may be used to stabilize operation of the linear regulator.

### TECHNICAL FIELD

The present disclosure relates generally to information handling systems, and more particularly, to stabilizing power supplies of the information handling systems.

### BACKGROUND

As the value and use of information continues to increase, individuals and businesses seek additional ways to process and store information. One option available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

The information handling system comprises a plurality of subsystems, e.g., processor blades, disk controllers, etc., these subsystems operate at certain direct current (DC) voltages and currents. Generally, these DC voltages and currents may be supplied through at least one power supply. A common and economical information handling system power supply may use a integrated circuit linear regulator, e.g., low drop out (LDO) voltage regulator, buck regulator, etc.

### SUMMARY

A problem exists, however, when selecting an output capacitor for the linear regulator in that regulator instability may result if the output capacitor has an equivalent series resistance (ESR) that is too large or too small for stable operation of the integrated circuit regulator. Heretofore power supply designers used output capacitors that had an ESR within a range required for stable operation of a linear regulator. However output capacitors having that ESR range are generally more expensive then the newer technology and lower cost capacitors. For example, a tantalum capacitor may have a desired ESR but is more expensive then a ceramic capacitor. The tantalum capacitor has a much higher ESR then does the ceramic capacitor. Since the tantalum capacitor ESR is within the stable operation range for a linear regulator it is generally used instead of the ceramic capacitor even though the ceramic capacitor is less costly then the tantalum capacitor and has a much lower ESR. Because the ceramic capacitor has a much lower ESR it has not been used as an output capacitor since it may cause the power supply linear regulator to become unstable.

According to the present disclosure, the resistance of a “bottle neck” land on a printed circuit board may be introduced as a connection(s) to the output capacitor so as to raise the apparent ESR of the output capacitor, e.g., a ceramic surface mount (SMD) capacitor, sufficiently for unconditional stable operation of the linear regulator. This resistive connection bottle neck may be one or both conductive lands of a printed circuit board that may connect the output capacitor to the linear regulator. The resistance of the conductive land may be determined by the land conductor cross sectional area and length. The cost to produce this bottle neck land may be trivial or substantially nothing since it only involves changing a printed circuit board etch pattern during fabrication of the power supply printed circuit board.

According to a specific example embodiment of this disclosure, an apparatus for supplying operating power to subsystems in an information handling system may comprise a linear regulator, a low series equivalent resistance (ESR) output capacitor, and a conductor having a desired resistance, wherein the conductor couples the low ESR output capacitor to an output of the linear regulator, and whereby the desired resistance of the conductor contributes to stable operation of the linear regulator.

According to another specific example embodiment of this disclosure, an apparatus for supplying operating power to subsystems in an information handling system may comprise a linear regulator, a low series equivalent resistance (ESR) output capacitor, and a first conductor and a second conductor having a combined desired resistance, wherein the first conductor couples a first node of the low ESR output capacitor to an output of the linear regulator, the second conductor couples a second node of the low ESR output capacitor to a common of the linear regulator, and whereby the desired resistance of the first and second conductors contributes to stable operation of the linear regulator.

According to yet another specific example embodiment of this disclosure, an apparatus for supplying operating power to subsystems in an information handling system may comprise a linear regulator, a low series equivalent resistance (ESR) output capacitor, and a conductor having a desired resistance, wherein the conductor couples the low ESR output capacitor to a common of the linear regulator, and whereby the desired resistance of the conductor contributes to stable operation of the linear regulator.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of an information handling system, according to specific example embodiments of the present disclosure;

FIG. 2 is a schematic diagram of a linear regulator on a printed circuit board, according to a specific example embodiment of the present disclosure;

FIG. 3 is a schematic diagram of a linear regulator on a printed circuit board, according to another specific example embodiment of the present disclosure; and

FIG. 4 is a schematic diagram of a linear regulator on a printed circuit board, according to yet another specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific example embodiments are schematically illustrated. Like elements in the drawings will be represented by like numbers, and similar elements will be represented by like numbers with a different lower case letter suffix.

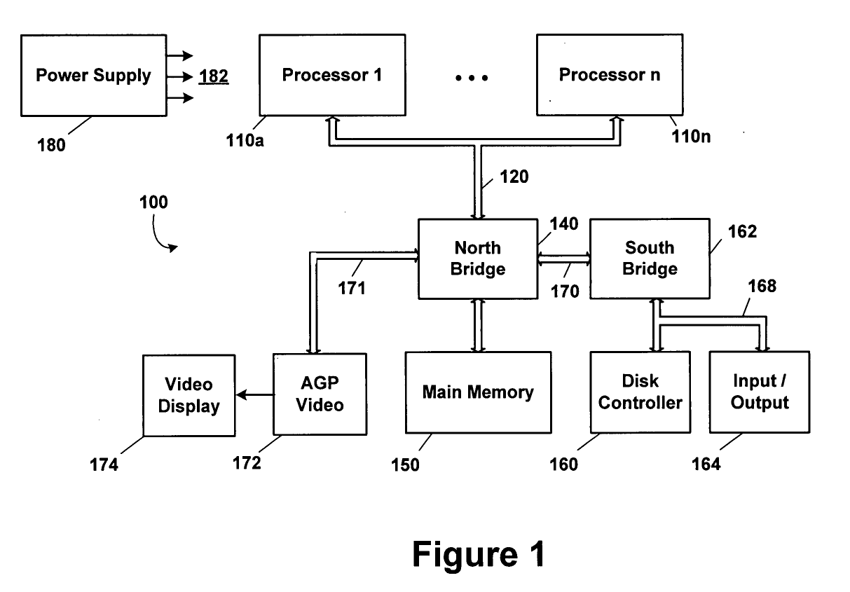

Referring to FIG. 1, depicted is an information handling system having electronic components mounted on at least one printed circuit board (PCB) (motherboard) and communicating data and control signals therebetween over signal buses, according to a specific example embodiment of the present disclosure. In one example embodiment, the information handling system is a computer system. The information handling system, generally referenced by the numeral 100, comprises a plurality of physical processors 110, generally represented by processors 110a-110n, coupled to a host bus(es) 120. A north bridge 140, which may also be referred to as a memory controller hub or a memory controller, is coupled to a main system memory 150. The north bridge 140 is coupled to the plurality of processors 110 via the host bus(es) 120. The north bridge 140 is generally considered an application specific chip set that provides connectivity to various buses, and integrates other system functions such as a memory interface. For example, an Intel 820E and/or 815E chip set, available from the Intel Corporation of Santa Clara, California, provides at least a portion of the north bridge 140. The chip set may also be packaged as an application specific integrated circuit (ASIC). The north bridge 140 typically includes functionality to couple the main system memory 150 to other devices within the information handling system 100. Thus, memory controller functions such as main memory control functions typically reside in the north bridge 140. In addition, the north bridge 140 provides bus control to handle transfers between the host bus 120 and a second bus(es), e.g., PCI bus 170, AGP bus 171 coupled to a video graphics interface 172 which drives a video display 174. A third bus(es) 168 may also comprise other industry standard buses or proprietary buses, e.g., ISA, SCSI, I²C, SPI, USB buses through a south bridge(s) (bus interface) 162. A disk controller 160 and input/output interface 164 may be coupled to the third bus(es) 168. One or more power supplies 180 may supply direct current (DC) voltage outputs 182 to the aforementioned components (subsystems) of the information handling system 100, and may comprise, for example, a power supply 180 for each voltage output 182 required by the subsystems of the information handling system 100.

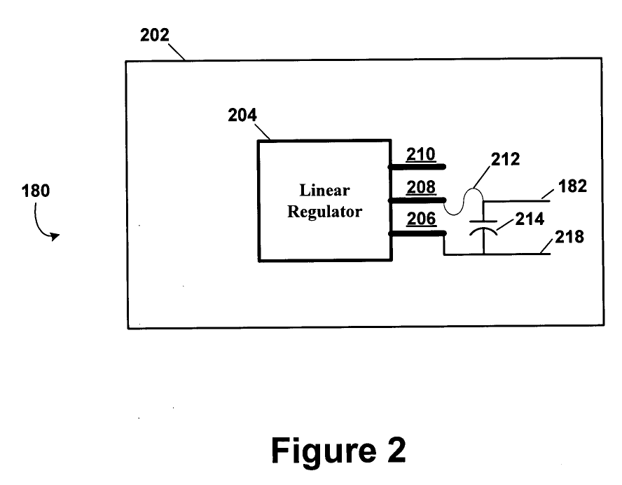

Referring to FIG. 2, depicted is a schematic diagram of a linear regulator on a printed circuit board, according to a specific example embodiment of the present disclosure. The power supply 180 may comprise a linear regulator 204 on a printed circuit board 202. An output capacitor 214, e.g., ceramic capacitor, may be coupled to an output 208 of the linear regulator 204 with a conductor 212 having a resistance that allows the linear regulator 204 to remain stable under all expected voltage and current operating conditions. The conductor 212 may raise the apparent ESR of the capacitor 214 sufficiently to be within an ESR range needed by the linear regulator 204 to remain stable even with an extremely low ESR capacitor 214 such as, for example but not limited to, a ceramic capacitor. The apparent ESR of the combination of the conductor 212 and the output capacitor 214 may be, for example but not limited to, about five milliohms.

The conductor 212 may be a “bottle-neck” in a printed circuit land on the printed circuit board 202. The resistance of the conductor 212 depends upon its cross sectional area and length. Any combination of cross-sectional area and length for the conductor 212 may be utilized according to this disclosure. Input 210 may be coupled to a source voltage. Common 206 may be coupled to the information handling system 100 ground or common power supply rail by, for example, terminal 218. An output voltage 182 may be obtained at the capacitor 214.

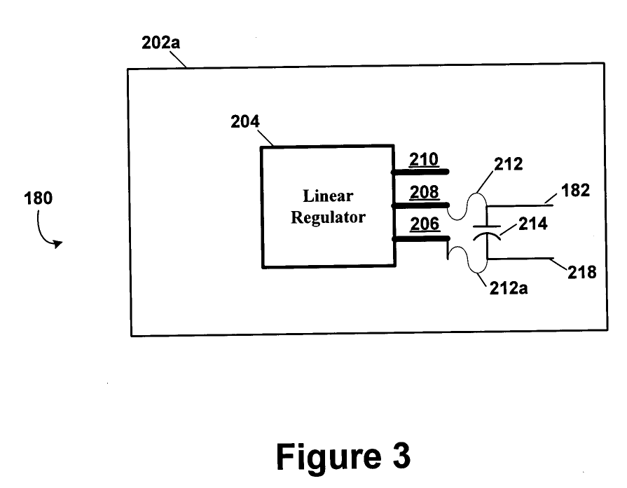

Referring to FIG. 3, depicted is a schematic diagram of a linear regulator on a printed circuit board, according to another specific example embodiment of the present disclosure. An output capacitor 214, e.g., ceramic capacitor, may be coupled to an output 208 of the linear regulator 204 with a conductor 212 and to a common 206 of the linear regulator 204 with a conductor 212a. The conductors 212 and 212a have resistances that allow the linear regulator 204 to remain stable under all expected voltage and current operating conditions. The conductors 212 and 212a may raise the apparent ESR of the capacitor 214 sufficiently to be within an ESR range needed by the linear regulator 204 to remain stable even with an extremely low ESR capacitor 214 such as, for example but not limited to, a ceramic capacitor. The apparent ESR of the combination of the conductors 212 and 212a, and the output capacitor 214 may be, for example but not limited to, about five milliohms.

The conductors 212 and 212a may be “bottle-necks” in printed circuit lands on the printed circuit board 202. The resistances of the conductors 212 and 212a depend upon their cross sectional areas and lengths. Any combination of cross-sectional areas and/or lengths for the conductors 212 and 212a may be utilized according to this disclosure. Input 210 may be coupled to a source voltage. An output voltage 182 may be taken at a node of the capacitor 214. The conductors 212 and 212a are located between the output 208 and the common 206, respectively and the capacitor 214.

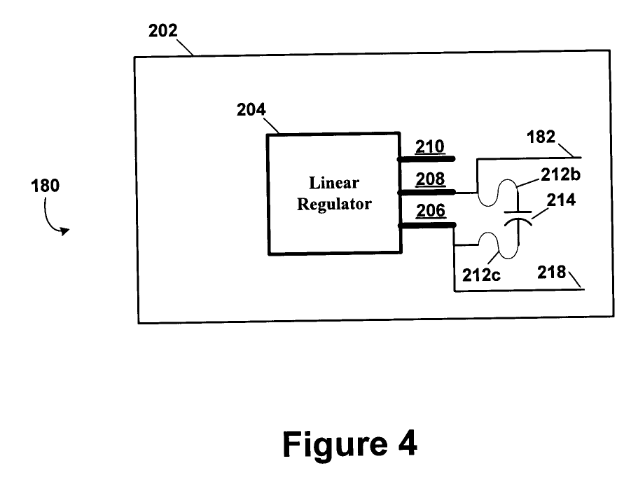

Referring to FIG. 4, depicted is a schematic diagram of a linear regulator on a printed circuit board, according to yet another specific example embodiment of the present disclosure. An output capacitor 214, e.g., ceramic capacitor, may be coupled to an output 208 of the linear regulator 204 with a conductor 212b and to a common 206 of the linear regulator 204 with a conductor 212c. The conductors 212b and 212c have resistances that allow the linear regulator 204 to remain stable under all expected voltage and current operating conditions. The conductors 212b and 212c may raise the apparent ESR of the capacitor 214 sufficiently to be within an ESR range needed by the linear regulator 204 to remain stable even with an extremely low ESR capacitor 214 such as, for example but not limited to, a ceramic capacitor. The apparent ESR of the combination of the conductors 212b and 212c, and the output capacitor 214 may be, for example but not limited to, about five milliohms.

The conductors 212b and 212c may be “bottle-necks” in printed circuit lands on the printed circuit board 202. The resistances of the conductors 212b and 212c depend upon their cross sectional areas and lengths. Any combination of cross-sectional areas and/or lengths for the conductors 212b and 212c may be utilized according to this disclosure. Input 210 may be coupled to a source voltage. Common 206 may be coupled to the information handling system 100 ground or common power supply rail by, for example, terminal 218. An output voltage 182 may be obtained at the output 208. The capacitor 214 is coupled to the output 208 and the common 206 by the conductors 212b and 212c, respectively.

It is contemplated and within the scope of this disclosure that any one or more combination of conductors 212, 212a, 212b and/or 212c may be effectively used to accomplish raising the apparent ESR of the capacitor 214 for stable operation of the linear regulator 204 by coupling a first node of the capacitor 214 to the output 208 of the linear regulator and/or a second node of the capacitor 214 to the common 206 of the linear regulator 204.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An apparatus for supplying operating power to subsystems in an information handling system, said power supply apparatus comprising:
a linear regulator;
a low series equivalent resistance (ESR) output capacitor; and
a conductor having a desired resistance, wherein the conductor couples the low ESR output capacitor to an output of the linear regulator, and whereby the desired resistance of the conductor contributes to stable operation of the linear regulator.

2. The apparatus according to claim 1, wherein the conductor having the desired resistance comprises a printed circuit board conductive land having a certain cross-sectional area and length that produces the desired resistance.

3. The apparatus according to claim 1, wherein apparent ESR of a combination of the conductor and the output capacitor is about five milliohms.

4. The apparatus according to claim 1, wherein the output capacitor is a ceramic capacitor.

5. The apparatus according to claim 1, wherein the conductor comprises a plurality of conductors that couple the output capacitor to the linear regulator.

6. The apparatus according to claim 5, wherein apparent ESR of a combination of the plurality of conductors and the output capacitor is about five milliohms.

7. The apparatus according to claim 1, wherein the conductor is between the linear regulator and the output capacitor, and an output terminal is coupled to the output capacitor.

8. The apparatus according to claim 1, wherein the conductor is between the linear regulator and the output capacitor, and an output terminal is coupled to the linear regulator.

9. An information handling system having the power supply apparatus according to claim 1.

10. An apparatus for supplying operating power to subsystems in an information handling system, said power supply apparatus comprising:
a linear regulator;
a low series equivalent resistance (ESR) output capacitor; and
a first conductor and a second conductor having a combined desired resistance, wherein the first conductor couples a first node of the low ESR output capacitor to an output of the linear regulator, the second conductor couples a second node of the low ESR output capacitor to a common of the linear regulator, and whereby the desired resistance of the first and second conductors contributes to stable operation of the linear regulator.

11. The apparatus according to claim 10, wherein the first and second conductors comprise printed circuit board conductive lands having certain cross-sectional areas and lengths that produce the desired resistance.

12. The apparatus according to claim 10, wherein apparent ESR of a combination of the first and second conductors and the output capacitor is about five milliohms.

13. The apparatus according to claim 10, wherein the output capacitor is a ceramic capacitor.

14. The apparatus according to claim 10, wherein the first conductor is between an output of the linear regulator and a first node of the output capacitor.

15. The apparatus according to claim 10, wherein the second conductor is between a common of the linear regulator and a second node of the output capacitor.

16. The apparatus according to claim 14, wherein an output terminal is coupled to the first node of the output capacitor.

17. The apparatus according to claim 14, wherein an output terminal is coupled to the output of the linear regulator.

18. The apparatus according to claim 15, wherein a common terminal is coupled to the second node of the output capacitor.

19. The apparatus according to claim 15, wherein a common terminal is coupled to the common of the linear regulator.

20. An information handling system having a power supply according to claim 10.

21. An apparatus for supplying operating power to subsystems in an information handling system, said power supply apparatus comprising:
a linear regulator;
a low series equivalent resistance (ESR) output capacitor; and
a conductor having a desired resistance, wherein the conductor couples the low ESR output capacitor to a common of the linear regulator, and whereby the desired resistance of the conductor contributes to stable operation of the linear regulator.
